(19) United States
(12) Patent Application Publication
(10) Pub. No.: US 2006/0022653 A1
(43) Pub. Date: Feb. 2, 2006

(54) System and method to mitigate transient energy

(76) Inventors: Byron M. Reed, Murphy, TX (US); Kevin M. Ovens, Frisco, TX (US)

Correspondence Address: TEXAS INSTRUMENTS INCORPORATED, P O BOX 655474, M/S 3999, DALLAS, TX, 75265, US

(21) Appl. No.: 10/901,672

(22) Filed: Jul. 29, 2004

(51) Int. Cl. G05F 1/40

(52) U.S. Cl. 323/282

(57) ABSTRACT

Systems and methods are disclosed to mitigate transient electrical energy that is supplied to a load. A power supply system can include a regulator that supplies regulated electrical energy to an associated load based on an operating mode of the system. A supplemental power supply supplies supplemental electrical energy to the associated load that varies over time to mitigate transient electrical characteristics in the electrical energy being supplied to the associated load due to an operating mode transition of the power supply system.

### TECHNICAL FIELD

This invention relates to integrated circuits, and more specifically relates to a system and method to mitigate transient energy in electrical circuits.

### BACKGROUND

Portable electronic devices continue to become increasingly complex. For example, mobile telephones are no longer limited to providing telephone functionality, but are also implementing multimedia and other functions. The increased complexity of portable devices imposes a tremendous burden on power consumption and battery lifetime. Despite the additional features being implemented in various devices, the manufacturers of these devices and their customers typically require substantially the same or even improved battery lifetime. Various types of power control systems have been developed that dynamically control the output voltage of a power supply.

One approach employs a power control system to operate a DC-DC buck converter for supplying the voltage to the core circuitry of the electronic device. FIG. 1 depicts an example of a power supply (e.g., including a DC-DC buck converter) 10 that can be used to provide regulated power for various applications. A control system 12 controls one or more switches of a switch network 14 to supply current to an associated load 16 through an inductor 18. A capacitor 20 is coupled across the load 16. The control system 12 calculates an error voltage and adjusts the output voltage of the converter 10 accordingly. In order to achieve performance with minimum energy consumption, the control system operates to minimize the voltage. Since the output voltage is set to a minimum, the amount of transient (e.g., undershoot or overshoot) in the converter should also be minimized. When the load changes from low current to high current, for example, the converter energizes the inductor 18 before the current can be supplied to the load 16. The delay in supplying the current to the load 16 causes the output voltage to droop or undershoot.

In view of the increased requirements of portable electronic devices, it is desirable to provide power supplies and converters that can mitigate transients.

### SUMMARY

One aspect of the present invention relates to a power supply system that includes a regulator that supplies regulated electrical energy to an associated load based on an operating mode of the system. A supplemental power supply supplies supplemental electrical energy to the associated load that varies over time to mitigate transient electrical characteristics in the electrical energy being supplied to the associated load due to an operating mode transition of the power supply system.

Another aspect of the present invention relates to a power supply system that includes a converter. The converter includes a high-side switch, a low-side switch, and an inductor coupled to a first node between the high-side switch and the low-side switch and an output node. An output capacitor is coupled to provide an output voltage across an associated load. A supplemental power supply is coupled to supply current to the output node. The current can be varied to mitigate at least one of undershoot and overshoot in the output voltage during at least a portion of an operating mode transition of the power supply system. The supplemental power supply further may operate as a clamp that connects between an input voltage and the load, thereby bypassing the inductor to supply the supplemental current to the load.

Still another aspect of the present invention relates to a method for mitigating transient electrical characteristics during an operating mode transition of a power supply. The method includes temporarily supplying supplemental current to a load in response to the operating mode transition. The supplemental current is adjusted during at least a portion of the operating mode transition to enable other current that is being supplied to the load to adjust based on the operating mode transition, as to mitigate transient electrical characteristics in the electrical energy being supplied to the load due to the operating mode transition.

### BRIEF DESCRIPTION OF THE DRAWINGS

FIG. 1 depicts an example of a conventional power supply with a DC-DC buck converter.

FIG. 2 depicts a power supply system that can be implemented in accordance with an aspect of the present invention.

FIG. 3 depicts an example of another power supply system that can be implemented in accordance with an aspect of the present invention.

FIG. 4 is a graph depicting the output voltages of a conventional converter and a converter implemented in accordance with an aspect of the present invention.

FIG. 5 is a graph depicting current supplied by a conventional converter and a converter implemented in accordance with an aspect of the present invention.

FIG. 6 depicts an example of yet another power supply system that can be implemented in accordance with aspect of the present invention.

FIG. 7 depicts an example of a portable electronic device implementing a power supply system in accordance with aspect of the present invention.

FIG. 8 depicts an example of a method for supplying power in accordance with aspect of the present invention.

### DETAILED DESCRIPTION

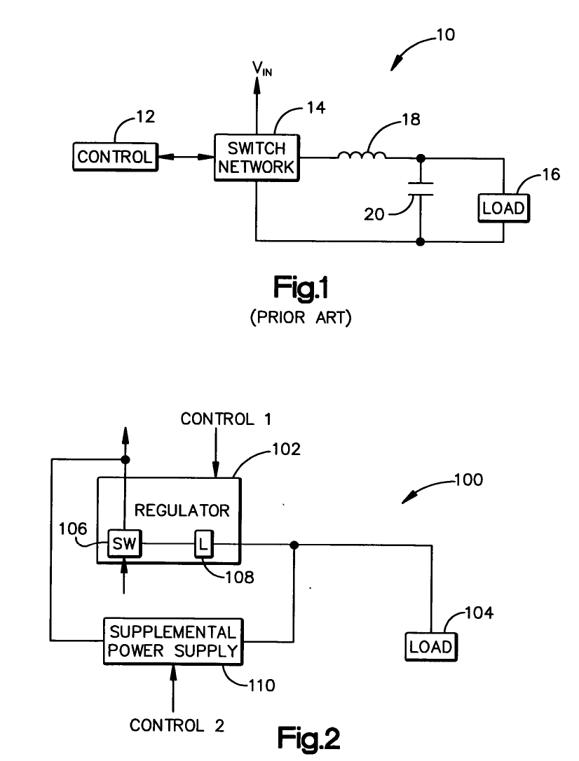

FIG. 2 depicts an example of a power supply system 100 that can be implemented in accordance with an aspect of the present invention. The power supply system 100 includes a regulator 102 that is coupled to supply regulated electrical energy (e.g., current) to provide a corresponding output voltage to an associated load 104. The regulator 102 provides the regulated electrical energy to the load 104 based on a control signal CONTROL 1. For example, the regulator 102 can include a switch network of one or more switches, indicated schematically at 106, which are modulated so that the regulator 102 provides electrical current through an associated component (e.g., an inductor), indicated at 108. The current through the component 108 drives the load 104, such as at a substantially fixed DC voltage that can vary based on the operating mode of the system. The load 104 further can operate in a plurality of modes having different power requirements for any number of such modes. Accordingly, the regulator 102 is controlled based on the CONTROL 1 signal to accommodate changes in the power requirements of the load 104.

As an example, the system 100 may operate in a first mode (e.g., a power conservation mode or sleep mode), in which the load 104 requires a low current from the regulator 102. In the first mode, the regulator 102 provides electrical current to the load 104 based on the CONTROL 1 input for energizing the load at a corresponding level. The system 100 can also operate in a second mode for providing a greater current to the load 104 than in the first mode. To provide the load 104 with sufficient current in the second mode, for example, the CONTROL 1 input modulates the switch network 106 to provide current through the component 108 that drives the load at a corresponding output voltage.

Since the system 100 has multiple operating modes, the regulator 102 is operative to transition between such modes, including the first and second modes, as well as potentially to other modes. The regulator 102 implements a transition from one mode to another mode modifies based on the CONTROL 1 signal. However, due to the inherent nature of the output component 108 (e.g., an inductor or other circuitry), the regulator 102 cannot change current instantaneously when a mode transition occurs. Consequently, there is a delay in meeting the new power requirements of the load associated with implementing the mode transition (e.g., from a first operating mode to a second operating mode). For instance, when supplying current to the load 104 through an inductor 108, the time required to modify the output voltage to a different voltage is functionally related to how quickly current through the inductor can change (e.g.,

$$( e . g . , \frac{ⅆ i}{ⅆ t} ) .$$

). Absent corrective measures, the delay can result in transients, such as undershoot or overshoot, may occur in the output voltage supplied to the load 104.

The system 100 includes a supplemental power supply 110 that mitigates transient electrical characteristics (voltage or current) that may occur during a mode transition. The supplemental power supply 110 connects between an input voltage and the load 104, effectively bypassing the component 108 of the regulator 102 and supplying supplemental current relative to the load 104 (e.g., sourcing or sinking current). The supplemental power supply 110 thus operates to clamp transient voltages that may be supplied to the load 104 due to an operating mode transition.

The supplemental power supply 110 is operative to supply supplemental electrical energy (e.g., current) to the load 104 that varies over time based on a control input signal, indicated at CONTROL 2. For instance, the CONTROL 2 signal controls the supplemental power supply 110 to supply electrical energy (e.g., current) that varies over time to substantially compensate for transient electrical characteristics in the electrical energy being supplied to the load due to the mode transition. The supplemental current thus enables the regulator 102 to stabilize and adjust the current to a new level according to the requirements of the load 104 for the new operating mode.

By way of further example, the supplemental power supply 110 can provide a greater amount of current to the load during an initial part of the mode transition and gradually be phased out during a latter part of the mode transition. That is, the supplemental power supply 110 can be controlled, based on CONTROL 2 signal, to implement the gradual phasing out of supplemental current commensurate with the delay in changing in the current that is provided by the regulator 102.

The supplemental power supply 110 can be implemented as one or more switches capable of providing electrical current relative to the load 104. The supplemental power supply 110 can be coupled to supply the supplemental current to drive the load 104 (e.g., by bypassing the component 108) more quickly than the regulator 102 can adjust its current to the load. To help further mitigate transients during the mode transition, the supplemental supply 110 operates with a variable duty cycle that is adjusted based on the CONTROL 2 signal. The duty cycle can be modified (e.g., decreased) over time, such as to gradually phase out the supplemental current that is supplied to the load 104. The supplemental power supply 110 and its associated control can be implemented by analog circuitry, digital components or a combination of analog and digital components.

The supplemental power supply 110, for example, can be configured to vary the supplemental current incrementally over time based on the ability of the regulator 102 to change the current due to a change in operating mode. The supplemental current thus can be adjusted or reduced during the mode transition based on feedback indicative of the power supplied by the load, based on the current through the switch network 106 of the regulator or based on a combination thereof. Alternatively, the supplemental power supply 110 can be configured to vary the supplemental current that is provided to the load in a predetermined manner. For instance, the CONTROL 2 signal can be decreased, such as over a plurality of clock cycles, to gradually phase out the supplemental electrical energy over a pre-designated time period (e.g., based on the design of the system 100).

Those skilled in the art will understand and appreciate the various other approaches that can be utilized to implement the supplemental power supply 110. For example, a weighted set of switches (e.g., field effect transistors (FETs)) can be employed to provide the variable current to the load based upon which switch or switches of the weighted set of switches are activated at a given time. For instance, initially, a set of switches can be activated to provide a maximum level of current, and selected subsets thereof can be selectively activated and deactivated to gradually reduce the supplemental current provided by the supplemental power supply 110. The activation time period for the supply 110 can be commensurate with the delay associated with transitioning the regulator 102 to supply different current levels required between respective modes. Those skilled in the art will appreciate various other approaches that can be utilized to implement the supplemental power supply 110 consistent with the teachings contained herein.

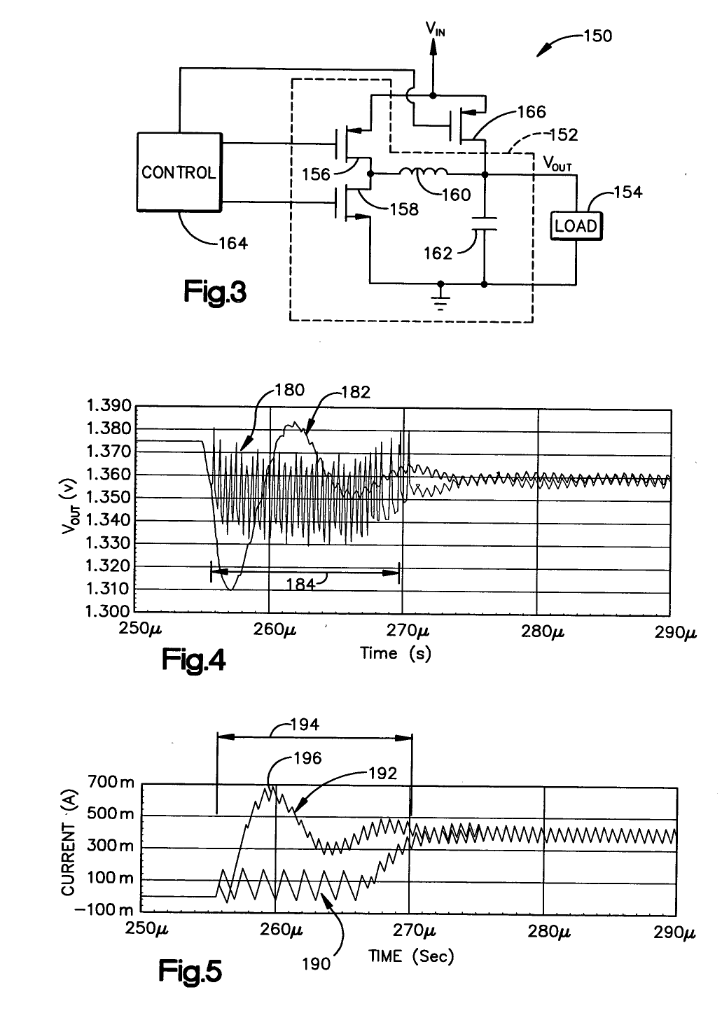

FIG. 3 depicts an example of a power supply system 150 that includes a DC-DC buck converter 152 operative to supply current to an associated load 154. In the example of FIG. 3, the converter 152 includes a pair of transistors 156 and 158 coupled in series between an input voltage V_{IN} and electrical ground. For instance, the transistor 156, which corresponds to a high-side switch device, can be implemented as a P-metal oxide semiconductor FET (PMOSFET) and the transistor 158, which corresponds to a low-side switch device, can be implemented as an NMOSFET. An inductor 160 is coupled to a node interconnected between the transistors 156 and 158 and the output of the converter 152. The inductor 160 is connected to supply electrical current to the load 154 to provide a corresponding output voltage V_{OUT}. A capacitor 162 is coupled in parallel with the load 154 between the output of the converter 152 and electrical ground to maintain V_{OUT} according to the operating mode.

A control system 164 is coupled to drive the gates of the respective transistors 156 and 158 according to the operating mode of the power supply system 150. For example, the control system 164 can operate in two or more modes. For the example of two operating modes, a first mode can correspond to a pulse frequency modulation (PFM, also known as a pulse mode or burst mode) and a second pulse width modulation (PWM) mode. The PFM mode can be utilized to obtain high efficiency at low load currents, and the PWM mode can be used for high current operation.

The system 150 also includes an additional transistor (e.g., a PMOSFET) 166 coupled between V_{IN} and the output of the converter 152, which output is connected with the load 154. The control system 164 is coupled to the gate of the transistor 166 for driving the transistor to provide supplemental current to the load 154, such as in response to transitions in the operating mode that change the power requirements of the load 154. The supplemental current varies over time to substantially compensate for transient electrical characteristics in the power being supplied to the associated load 154 due to an operating mode transition of the system 150. Since, the transistors 156 and 166 can each be coupled to V_{IN}, the system can be implemented as an integrated circuit that requires no extra pins from that required for implementing a conventional converter topology.

By way of example, assuming that the converter 152 starts in the high current PWM mode, the control system 164 will transition the converter 152 to the PFM mode when the electrical current through the transistor 156 drops below a current threshold. The control system 164 operates the transistor 166 to provide supplemental current during a mode transition, such as from the PFM mode to the PWM mode. For instance, the control system 164 can activate the transistor 166 (e.g., by modulating with a duty cycle) when the output voltage V_{OUT} is less than a predetermined threshold voltage. The control system 164 can turn off the transistor 166 if V_{OUT} increases above the threshold voltage.

In the example of FIG. 3, the control system 164 drives the gate of the transistor 166 with a time varying duty cycle to gradually phase out the supplemental current that is provided to the load 154 via the transistor 166. The control system 164 can implement the gradual phasing out of the supplemental current provided by the transistor 166 based on feedback indicative of the V_{OUT}. Alternatively, the control system 164 can control the phasing out of the supplemental current provided by the transistor 166 in a predetermined manner (e.g., incrementally), such as gradually over a predetermined number of clock cycles.

For example, the gradual phasing out of the supplemental current provided by the transistor 166 can be implemented by reducing the duty cycle of the control input to the gate of the transistor 166 in an incremental or stepwise manner. For instance, the duty cycle of the control signal at the gate of the transistor 166 can be reduced from 100% to 50% to 25% to 12.5% to an OFF condition over a plurality of clock cycles (e.g., periodically implementing each stepwise reduction), thereby providing a piecewise linear phasing out or gradual reduction of the duty cycle. The gradual reduction in the duty cycle of the transistor 166 enables the high current PWM mode of the converter 152 to take over and, thereby minimizes the undershoot of V_{OUT}.

By way of further illustration, FIG. 4 depicts a graph comparing V_{OUT} for a converter implementing the supplemental power supply according to an aspect of the present invention, indicated at 180, and V_{OUT} for a transient response of a conventional buck converter, indicated at 182. In the particular example of FIG. 4, the plots 180 and 182 depict simulation conditions in which V_{IN}=3.6 volts, V_{OUT}=1.36 volts, and a threshold voltage of 1.35 volts is utilized for controlling the supplemental power supply. Additionally, the components are implemented such that the inductor (e.g., the inductor 160 of FIG. 3) is 6.8 μH, the capacitor 162 is set at 10 μF, and with a frequency of 1.5 MHz in the PWM mode. As shown in the comparison of the output voltages 180 and 182, the output voltage 180 demonstrates a gradual reduction in duty cycle over the mode transition time period, indicated at 184, during which the supplemental power is activated and phased out.

FIG. 5 depicts a graph illustrating a simulation of current through an inductor (e.g., the inductor 160 of the converter 152 shown in FIG. 3) for two circuit topologies. A first plot of the current, indicated at 190, represents a converter implementing the supplemental power supply according to an aspect of the present invention, and a second current plot, indicated at 192, represents a transient response of a conventional buck converter. In the simulation represented in FIG. 5, the current 190 illustrates the current ramping up over a latter part of a mode transition time period, indicated at 194, during which the supplemental power is supplied (e.g., corresponding to a reduction in the duty cycle of the transistor 166 in FIG. 3). In contrast, the inductor current 192 exhibits a transient or spike 196 during an initial part of the transition period 194 and then gradually stabilizes to the desired level. The current spike 196 corresponds to a voltage undershoot (e.g., see FIG. 4) associated with transitioning from a higher output voltage to a lower output voltage.

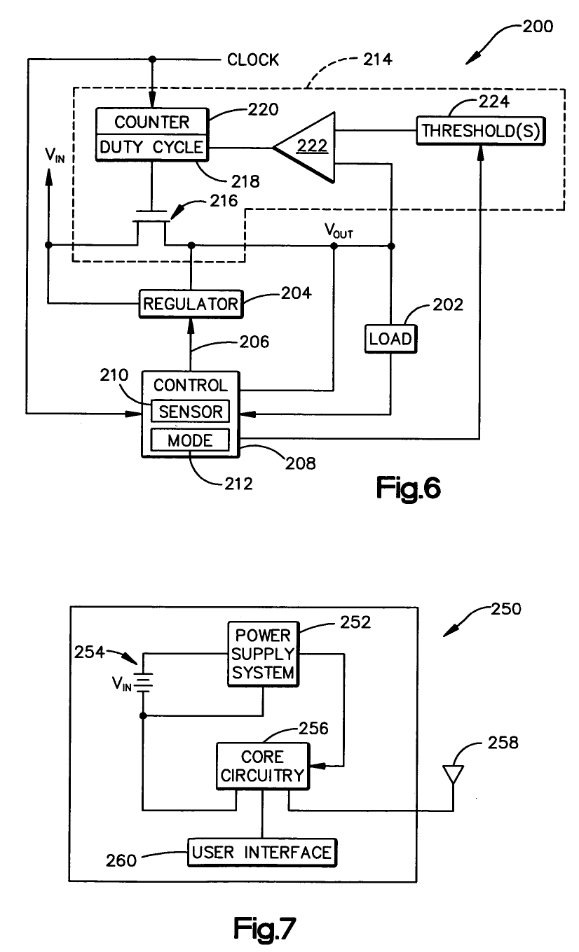

FIG. 6 depicts another example of a power supply system 200 that can be utilized to provide electrical energy to an associated load 202 according to an aspect of the present invention. The power supply system 200 includes a regulator 204 that is coupled to provide current to the load 202 based on a control signal 206 provided by a control system 208. The regulator 204 provides the electrical current to the load 202 as to provide a desired regulated output voltage V_{OUT} to the load, such as a DC voltage.

The control system 208 is depicted as having a sensor block 210 and a mode block 212. The sensor block 210 is operative to sense one or more electrical characteristics associated with other parts of the system. For example, the sensor block 210 can measure current through a part of the regulator 204 or the output voltage V_{OUT} provided to the load 202. The control system 208 employs the one or more sensed electrical characteristics as feedback to vary the control signal 206 to the regulator 204. The mode block 212 is operative to control an operating mode of the power supply system 200, which mode can vary as a function of the electrical characteristic or characteristics sensed by the sensor 210 or based on instructions from core circuitry of the load.

Those skilled in the art will understand and appreciate that the power supply system 200 can be configured to operate in any number of a plurality of operating modes and, in turn, supply different levels of electrical current according to power requirements of the load, which requirements can change based on the operating mode. The regulator 204, for instance, can be implemented as a DC-DC buck converter, although those skilled in the art will understand and appreciate that various different converter topologies can be utilized, which may vary based on the particular application in which the power supply system 200 is being utilized.

The system 200 also includes a supplemental power supply system 214 that is operative to supply supplemental current to the load 202 to compensate for changes in V_{OUT} required by the load 202. The supplemental power supply system 214 provides supplemental current, which varies over time, to enable the control system and regulator 204 to stabilize and modify the current due to an operating mode transition. The supplemental power supply system 214 includes an output switch device 216, such as a transistor (PMOS or NMOS) that is modulated with a duty cycle by a duty cycle control 218. The duty cycle control 218 modulates the control input (e.g., gate) of the switch device 216 with a variable duty cycle (e.g., by PWM). The duty cycle can vary, for example, during the transition between operating modes of the power supply system 200 to gradually phase out the supplemental current being provided. By operating the switch device 216 with a varying duty cycle during the mode transition, the current supplied by the regulator 204 can ramp to a next level, and the supplement current provided by the system 214 can then be terminated.

The duty cycle control 218 can implement the gradual phasing out of the supplemental current over time during the transition between operating modes. For example, a counter 220 can be associated with the duty cycle control 218. The counter 220 can increment from a predetermined start value to a final or stop value based on a CLOCK signal. The duty cycle control 218 can increment the decrease gradually or periodically based on the counter value, such as by reducing the duty cycle by a predetermined amount every N clock cycles, where N is a positive integer denoting a number of clock cycles. By varying the duty cycle of the switch device 216 in a generally piecewise linear manner, a corresponding stepwise change in the supplemental current provided by the system 214 can be achieved during a mode transition over a predetermined time period. The time period can be determined based on the configuration of the system and performance requirements thereof.

The system 214 also includes a comparator 222 that provides an output signal to the duty cycle control 218. The comparator 222 provides the output signal based on a comparison of the output voltage V_{OUT} and one or more thresholds, indicated at 224. The number of thresholds, for example, can vary based upon the number of operating modes being implemented by the power supply system 200, with a particular threshold being employed at a given time being selected based on the operating mode. For example, the control system 208 can, based on the mode control block 212, provide a signal to select which of the plurality of thresholds are utilized by the comparator 222 for controlling the duty cycle of the switch device 216. For a case in which there are two operating modes, a single threshold can be utilized.

In an example when the system 200 transitions from a low current (e.g., PFM) mode to a high current (e.g., PWM) mode, the comparator 222 can provide an output signal to the duty cycle control 218 if V_{OUT} is less than the predetermined threshold voltage 224. Accordingly, if V_{OUT} increases above the threshold voltage 224, the supplement system 214 can be turned off. Continuing with the above example, if V_{OUT} drops below the threshold voltage 224, the comparator 222 provides a corresponding output signal to activate the duty cycle control 218. The duty cycle control 218, in turn, activates the output switch device 216 to provide supplemental current at a level and for a duration (e.g., a plurality of clock cycles) that allows the feedback signal from V_{OUT} to the control block 208 to stabilize. After the feedback signal has adequately stabilized, the duty cycle for the switch device 216 and the duty cycle of corresponding switches in the regulator are aligned. The duty cycle control 218 can then gradually (e.g., over a plurality of clock cycles) decrease the duty cycle of the switch device 216 from about 100% to an off condition based on the value of the counter 220. The step size for reducing the duty cycle of the switch device 216 can be implemented in various increments as to achieve a desired gradual reduction in the duty cycle.

Those skilled in the art will appreciate that the gradual phasing out of the supplemental current allows the high current mode implemented by the regulator 204 and the control system 208 to ramp up and provide output current to the load 202, and thereby minimize undershoot. Those skilled in the art will further understand and appreciate that a similar control mechanism can be utilized to minimize overshoot, such as by sinking current away from an output load, such as when transitioning from a high current mode to a low current mode.

FIG. 7 depicts an example of a portable electronic apparatus 250, such as a mobile communications device (e.g., a cellular telephone, personal digital assistant, portable computer and the like) implementing a power supply system 252 according to an aspect of the present invention. Those skilled in the art will understand and appreciate various implementations for the power supply system 252 based on the teachings contained herein, including but not limited to those shown and described with respect to FIGS. 1, 2, 3, 6 and 8.

The power supply system 252 is coupled to a battery 254 for converting an input voltage from the battery to a desired level. The power supply system 252 provides regulated power to associated core circuitry 256, which power can vary based on an operating mode of the apparatus 250. The core circuitry 256 can include analog or digital components configured and/or programmed to implement the functionality of the particular type of apparatus 250 being implemented. In the example of FIG. 7, the core circuitry 256 is coupled to an antenna 258, such as for transmitting or receiving wireless communication signals. A user interface 260 can also be coupled to the core circuitry 256 for providing input instructions from a user to the core circuitry.

By way of example, the apparatus 250 can operate in a plurality of operating modes, including at least a low power sleep mode and an active (or normal) mode. The power supply system 252 is configured to mitigate transients that might occur during a transition between operating modes according to an aspect of the present invention. A mode transition can occur, for example, in response to receiving a signal at the antenna 258 or in response to a user input provided to the user interface 260. As described herein, the power supply system 252 includes fast-acting circuitry (e.g., a switch) that is activated to provide supplemental current relative to the core circuitry (a load) 256 during a mode transition. The supplemental current can be gradually reduced over time and then phased out when a regulator portion of the power supply system can ramp output current (e.g., up or down) to the level required in the new operating mode. As a result, transients in the electrical characteristics in the electrical energy being supplied to the core circuitry 256 due to an operating mode transition are mitigated.

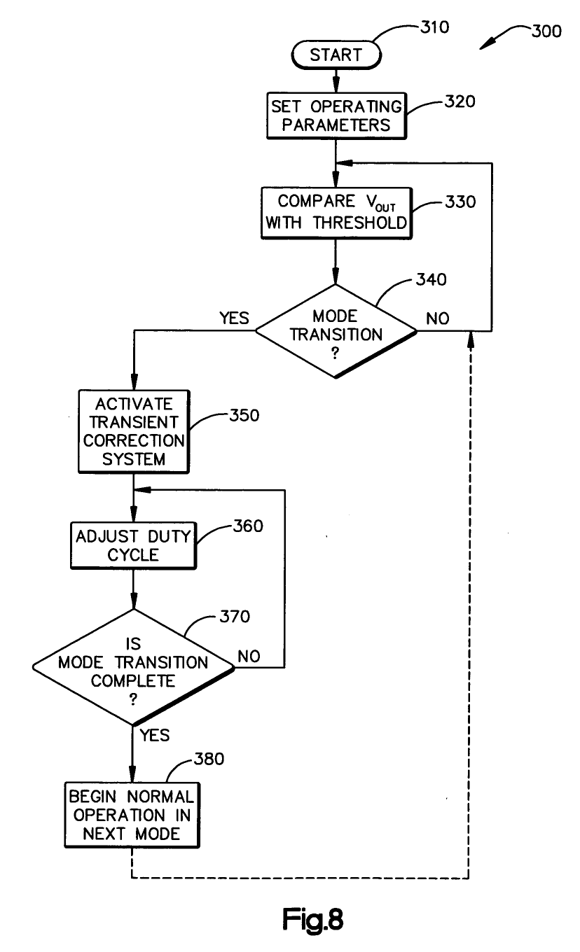

Referring now to FIG. 8, there is illustrated a methodology 300 in accordance with an aspect of the present invention. While, for purposes of simplicity of explanation, the methodology 300 is shown and described as executing serially, it is to be understood and appreciated that the present invention is not limited by the order shown, as some aspects may, in accordance with the present invention, occur in different orders or concurrently from that shown and described herein. Moreover, not all features shown or described may be needed to implement a methodology in accordance with the present invention. Additionally, such methodology can be implemented in hardware (e.g., analog circuitry, digital circuitry or a combination thereof), software (e.g., running on a DSP or ASIC) or a combination of hardware and software.

FIG. 8 depicts an example of a methodology that can be implemented in accordance with an aspect of the present invention. The methodology 300 can be utilized to mitigate one or both of undershoot and overshoot, such as may accompany a transition between different operating modes. The methodology begins at 310, such as in conjunction with powering up a power supply that forms part of an electrical device that has been turned to an on condition. At 320, operating parameters are set. The operating parameters can include establishing one or more voltage thresholds, setting an input voltage and setting desired output voltages. The operating parameters can also set an operating clock frequency, such as based on a system clock that is utilized for modulating corresponding components, such as transistors, for implementing the various modes of operation for supplying power to an associated load.

At 330, an output voltage V_{OUT} from the power supply is compared relative to a threshold. The threshold can be set by a control system, which further can vary as a function of an operating mode of the system and the types of mode transitions for which transient protection is desired. At 340, a determination is made as to whether a mode transition is occurring based on the comparison at 330. For example, a mode transition can occur if the V_{OUT} is less than a corresponding threshold voltage, such as for implementing undershoot protection. Additionally, or alternatively, a mode transition can occur, if the V_{OUT} exceeds another threshold, which corresponds to transitioning from a high current mode to a low current mode (and overshoot protection is implemented).

When a mode transition occurs (YES), the methodology proceeds to 350. For purposes of simplicity of explanation, the remaining portion of the methodology 300 will assume the occurrence of a mode transition from a low current mode to a high current mode, such as when V_{OUT} is less than a corresponding threshold. At 350, a transient correction system is activated, such as by controlling a switch device (or switch network) with a start duty cycle (e.g., 100%) to provide a supplemental current to the associated load. In this example, the supplemental current will increase the amount of current provided to the load. Alternatively, in order to implement overshoot protection, a corresponding in current decrease (e.g., by implementing a clamping system that sinks current away from the load) can be implemented relative to a load.

At 360, the duty cycle associated for the supplemental current is adjusted. Thus, to decrease the amount of supplemental current, the duty cycle of a switch is decreased accordingly. At 370, a determination is made as to whether the transition to the next mode has completed. This determination can be based on a measurement of the current through an inductor of the converter or based on the whether the duty cycle of the supplemental clamp supply has reached its final or minimum value (e.g., 0% or off). If mode transition has not completed (NO), the methodology returns to 360 to further adjust the duty cycle. Thus, the methodology 300 can loop between 360 and 370 to implement a desired gradual reduction in the duty cycle, such as described herein. The modification to the duty cycle at 360, for example, can be implemented in discrete steps or the modification can be continuous over a designated time period, with the amount of decrease controlled to implement a gradual phasing out of the supplemental current being provided during the transition between operating modes.

After the mode transition has completed (YES), from 370 the methodology proceeds to 380. At 380, normal operation can begin for the next operating mode (e.g., a high current or PWM mode). Those skilled in the art will understand and appreciate that gradual reduction of the duty cycle allows subsequent mode that is being transitioned to take over while mitigating transients in V_{OUT}.

What have been described above are examples of the present invention. It is, of course, not possible to describe every conceivable combination of components or methodologies for purposes of describing the present invention, but one of ordinary skill in the art will recognize that many further combinations and permutations of the present invention are possible. For example, the systems and methods described herein can be applied to various types of electrical and electromechanical systems, such as including control of motors (e.g., servo motors, stepper motors, linear motors) by mitigating overshoot and/or undershoot in target voltage or current levels being supplied to drive such motors. Accordingly, the present invention is intended to embrace all such alterations, modifications, and variations that fall within the spirit and scope of the appended claims.

What is claimed is:

1. A power supply system, comprising:
a regulator that supplies regulated electrical energy to an associated load based on an operating mode of the system; and
a supplemental power supply that supplies supplemental electrical energy to the associated load that varies over time to mitigate transient electrical characteristics in the electrical energy being supplied to the associated load due to an operating mode transition of the power supply system.

2. The system of claim 1, further comprising a control system that controls the supplemental power supply to supply the supplemental electrical energy during the operating mode transition.

3. The system of claim 2, wherein the control system controls the supplemental power supply to gradually phase out the supplemental electrical energy substantially commensurate with a delay of the regulator converter to adjust the regulated electrical energy to a level required by the associated load in a subsequent operating mode after the operating mode transition.

4. The system of claim 2, wherein the control system controls the supplemental power supply based on at least an output voltage supplied to the load relative to at least one voltage threshold.

5. The system of claim 1, wherein the supplemental power supply comprises a switch device coupled to supply the supplemental electrical energy as a supplemental current based on a duty cycle of the switch device.

6. The system of claim 5, further comprising a duty cycle control that controls the duty cycle of the switch device to vary over time during the operating mode transition to mitigate the transient electrical characteristics.

7. The system of claim 6, wherein the duty cycle control reduces the duty cycle of the switch device during the operating mode transition to reduce the supplemental current accordingly.

8. The system of claim 1, wherein the regulator further comprises at least one component that imposes a delay in modifying the regulated electrical energy to the electrical energy required by the associated load in the operating mode after the operating mode transition, the supplemental power supply being activated to mitigate the transient electrical characteristics resulting from the delay.

9. The system of claim 8, wherein the regulator further comprises:
a high-side switch;
a low-side switch;
an inductor coupled to a node between the high-side switch and the low-side switch for providing electrical current to the associated load; and
an output capacitor coupled across the associated load, the supplemental power supply being coupled to bypass the inductor and to supply the supplemental electrical energy as a supplemental current.

10. The system of claim 9, wherein the supplemental power supply comprises a switch device coupled to an output node between the inductor and the output capacitor to supply the supplemental electrical energy as a supplemental current to the associated load based on a duty cycle of the switch device.

11. The system of claim 10, further comprising a duty cycle control that varies the duty cycle of the switch device during at least a portion of the operating mode transition to mitigate the transient electrical characteristics, the duty cycle control varying the duty cycle from an initial duty cycle to a final duty cycle that is less than the initial duty cycle.

12. The system of claim 11, wherein the duty cycle control varies the duty cycle in one of discrete steps or continuously during the at least the portion the operating mode transition.

13. A portable electronic apparatus comprising the power supply system of claim 1, the apparatus further comprising at least one battery that supplies power to the power supply system.

14. A power supply system, comprising:
a converter comprising:
a high-side switch;
a low-side switch;
an inductor coupled to a first node between the high-side switch and the low-side switch and an output node; and
an output capacitor coupled to provide an output voltage across an associated load, and
a supplemental power supply coupled to supply current to the output node, the current being varied to mitigate at least one of undershoot and overshoot in the output voltage during at least a portion of an operating mode transition of the power supply system.

15. The power supply system of claim 14, further comprising a control system that controls the high-side switch and the low-side switch to provide current through the inductor to the associated load based the operating mode, the control system also controlling the supplemental power supply to supply the supplemental electrical energy during the at least the portion of the operating mode transition.

16. The system of claim 15, wherein the control system controls the supplemental power supply to gradually phase out the supplemental current substantially commensurate with a delay associated with changing the current through the inductor to a level required by the operating mode after the operating mode transition.

17. The system of claim 14, further comprising a control system that controls the supplemental power supply based on the output voltage relative to at least one threshold.

18. The system of claim 14, wherein the supplemental power supply comprises a switch device coupled to bypass the inductor and to supply the supplemental current to the output node.

19. The system of claim 18, further comprising a duty cycle control that controls a duty cycle of the switch device to vary over time during the at least the portion of the operating mode transition to mitigate the transient electrical characteristics.

20. The system of claim 19, wherein the duty cycle control reduces the duty cycle of the switch device during the at least the portion of the operating mode transition to phase out the supplemental current as the current through the inductor changes in response to the operating mode transition.

21. A power supply system, comprising:
means for supplying regulated power to a load, the regulated power being adjusted based on an operating mode of the power supply system; and
means for providing supplemental power to the load in response to a transition from a first operating mode to a second operating mode and for gradually phasing out the supplemental power to substantially compensate for a delay associated with the means for supplying adjusting the regulated power required in the second operating mode.

22. A method for mitigating transient electrical characteristics during an operating mode transition of a power supply, the method comprising:
in response to the operating mode transition, temporarily supplying supplemental current to a load; and
adjusting the supplemental current during at least a portion of the operating mode transition to enable other current that is being supplied to the load to adjust based on the operating mode transition, as to mitigate transient electrical characteristics in the electrical energy being supplied to the load due to the operating mode transition.

23. The method of claim 22, wherein the adjusting further comprises gradually phasing out the supplemental current during a transition from a first operating mode to a second operating mode, the first and second operating modes having different power requirements for the load.

24. The method of claim 23, further comprising modifying a duty cycle of a switch device that supplies the supplemental current to the load to gradually phase out the supplemental current.

25. The method of claim 22, wherein the supplying supplemental current further comprises bypassing a time-varying component of the power supply, through which the other current is provided, to supply the supplemental current to the load.

26. The method of claim 22, further comprising detecting the operating mode transition based on an output voltage relative to a threshold.
